(19) United States
(12) Patent Application Publication
(10) Pub. No.: US 2021/0395150 A1
(43) Pub. Date: Dec. 23, 2021

(54) CERAMIC MATERIAL BASED ON ZIRCONIUM OXIDE HAVING FURTHER OXIDES AND LAYER SYSTEM

(71) Applicant: Siemens Energy Global GmbH & Co. KG, Munich, Bayern (DE)

(72) Inventors: Arturo Flores Renteria, Berlin (DE); Werner Stamm, Mülheim an der Ruhr (DE); Dimitrios Zois, Berlin (DE)

(73) Assignee: Siemens Energy Global GmbH & Co. KG, Munich, Bayern (DE)

(21) Appl. No.: 17/272,292

(22) PCT Filed: Aug. 7, 2019
(86) PCT No.: PCT/EP2019/071201

§ 371 Date: Feb. 27, 2021

(30) Foreign Application Priority Data
Sep. 7, 2018 (DE) 10 2018 215 223.3

(51) Int. Cl. C04B 35/48; C22C 19/00; C23C 28/00

(52) U.S. Cl. CPC C04B 35/48; C22C 19/00; C23C 28/3215; C04B 2235/3229; C04B 2235/3225; C04B 2235/3206; C04B 2235/3208; C23C 28/3455

(57) ABSTRACT

A ceramic material, in particular for use in a layer system, which has high resistance to sintering, high expansion tolerance and low thermal conductivity and is provided by deliberately choosing the additions of oxides to zirconium oxide.

### CROSS REFERENCE TO RELATED APPLICATIONS

This application is the US National Stage of International Application No. PCT/EP2019/071201 filed 7 Aug. 2019, and claims the benefit thereof. The International Application claims the benefit of German Application No. DE 10 2018 215 223.3 filed 7 Sep. 2018. All of the applications are incorporated by reference herein in their entirety.

### FIELD OF INVENTION

The invention relates to a ceramic material which can be employed, in particular, for use of ceramic layers.

### BACKGROUND OF INVENTION

The use of zirconium oxide-based ceramic materials is known from the use for ceramic heat shields as solid material or ceramic protective coatings on turbine blades or high-temperature components. It is important that a high sintering resistance, phase stability, a high fracture toughness and a high expansion tolerance is ensured.

### SUMMARY OF INVENTION

It is therefore an object of the invention to improve existing materials systems.

The object is achieved by a ceramic material as claimed in claim 1.

The further dependent claims set forth further advantages which can be combined with one another in any way in order to achieve further advantages.

### BRIEF DESCRIPTION OF THE DRAWINGS

FIGS. 1 and 2 schematically show layer systems made up of a ceramic material.

### DETAILED DESCRIPTION OF INVENTION

It is proposed that from 4 mol % to 30 mol % of yttrium oxide (Y₂O₃), cerium oxide (CeO₂), calcium oxide (CaO) and/or magnesium oxide (MgO) be used as further oxides and/or from 2 mol % to 30 mol % of erbium oxide (Er₂O₃) and/or ytterbium oxide (Yb₂O₃) be used as base oxide(s).

Further advantageous proportions of the oxides are as follows: from 2 mol % to 30 mol % of base oxides, in particular from 4 mol % to 30 mol %, very particularly preferably from 6 mol % to 30 mol %, base oxides, and/or from 4 mol % to 30 mol % of further oxides, in particular from 4 mol % to 28 mol %, very particularly preferably from 4 mol % to 26 mol %, of further oxides, or from 6 mol % to 30 mol % of further oxides, in particular from 8 mol % to 30 mol %, very particularly preferably from 10 mol % to 30 mol %, of further oxides, or from 6 mol % to 28 mol % of further oxides, in particular from 6 mol % to 26 mol %, very particularly preferably from 10 mol % to 28 mol %, of further oxides.

Such a ceramic layer has, in particular, a layer thickness of from 20 μm to 1000 μm, in particular up to 2000 μm, and can preferably be produced by means of thermal spraying, in particular APS or EB-PVD.

The ceramic material has a high sintering resistance, a high expansion tolerance and high fracture toughness and also has a low thermal conductivity.

Working examples (not exhaustive) are:

### ZrO₂+

Er₂O₃

Yb₂O₃

Er₂O₃+Yb₂O₃

CeO₂

CaO

MgO

CeO₂+CaO

CeO₂+MgO

CaO+MgO

Y₂O₃+CeO₂

Y₂O₃+CaO

Y₂O₃+MgO

CeO₂+CaO+MgO

Y₂O₃+CaO+MgO

Y₂O₃+CeO₂+MgO

Y₂O₃+CeO₂+CaO

Y₂O₃+CeO₂+CaO+MgO

Y₂O₃+Yb₂O₃

Y₂O₃+Er₂O₃

Y₂O₃+Yb₂O₃+Er₂O₃

CeO₂+Yb₂O₃

CeO₂+Er₂O₃

CeO₂+Yb₂O₃+Er₂O₃

CaO+Yb₂O₃

CaO+Er₂O₃

CaO+Yb₂O₃+Er₂O₃

MgO+Yb₂O₃

MgO+Er₂O₃

MgO+Yb₂O₃+Er₂O₃

Y₂O₃+CeO₂+Yb₂O₃

Y₂O₃+CeO₂+Er₂O₃

Y₂O₃+CeO₂+Yb₂O₃+Er₂O₃

Y₂O₃+CaO+Yb₂O₃

Y₂O₃+CaO+Er₂O₃

Y₂O₃+CaO+Yb₂O₃+Er₂O₃

Y₂O₃+MgO+Yb₂O₃

Y₂O₃+MgO+Er₂O₃

Y₂O₃+MgO+Yb₂O₃+Er₂O₃

Y₂O₃+CeO₂+CaO+Yb₂O₃

Y₂O₃+CeO₂+CaO+Er₂O₃

Y₂O₃+CeO₂+CaO+Yb₂O₃+Er₂O₃

Y₂O₃+CeO₂+MgO+Yb₂O₃

Y₂O₃+CeO₂+MgO+Er₂O₃

Y₂O₃+CeO₂+MgO+Yb₂O₃+Er₂O₃

Y₂O₃+CaO+MgO+Yb₂O₃

Y₂O₃+CaO+MgO+Er₂O₃

Y₂O₃+CaO+MgO+Yb₂O₃+Er₂O₃

Y₂O₃+CaO+MgO+CeO₂+Yb₂O₃

Y₂O₃+CaO+MgO+CeO₂+Er₂O₃

Y₂O₃+CaO+MgO+CeO₂+Yb₂O₃+Er₂O₃

CeO₂+CaO+Yb₂O₃

CeO₂+CaO+Er₂O₃

CeO₂+CaO+Yb₂O₃+Er₂O₃

CeO₂+MgO+Yb₂O₃

CeO₂+MgO+Er₂O₃

CeO₂+MgO+Yb₂O₃+Er₂O₃

CaO+MgO+Y₂O₃

CaO+MgO+CaO+Yb₂O₃

CaO+MgO+Y₂O₃+Yb₂O₃

CaO+MgO+CeO₂+Yb₂O₃

CaO+MgO+CeO₂+Er₂O₃

CaO+MgO+CeO₂+Yb₂O₃+Er₂O₃

ZrO₂+Y₂O₃ is not according to the invention (disclaimer).

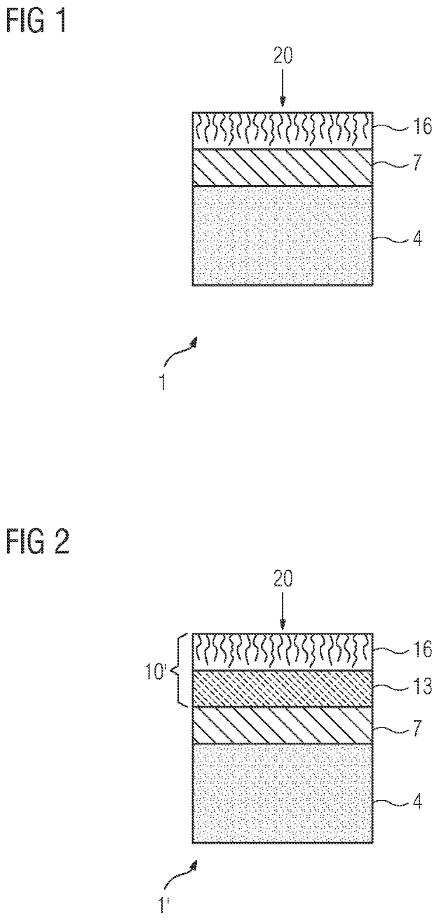

FIG. 1 shows a layer system 1 according to the invention.

The layer system 1 has a substrate 4. The substrate 4 is, in particular, a nickel-based superalloy or represents a CMC substrate.

A bonding layer which in the case of a nickel-based superalloy is, in particular, an NiCoCrAlY-based alloy or an aluminide or platinum-aluminide layer is present on the substrate 4.

An oxide layer (TGO) is formed on this metallic bonding layer during coating or during operation.

A ceramic layer as per the ceramic material has been applied to this oxide layer (TGO) or to the metallic bonding layer 7.

In the case of a ceramic substrate 4 (CFC), a bonding layer for the ceramic layer 10 may not be necessary.

FIG. 2 shows a variant in which the ceramic protective layer 10′ of the layer system 1′ is formed with two sublayers. As regards the substrate 4 and/or the substrate materials of the bonding layer 7, what has been said in the case of FIG. 1 applies analogously. However, the outermost ceramic layer 16 here forms the ceramic material of the invention.

Under this ceramic layer 16, there is a ceramic bonding layer 13 for the purpose of matching coefficients of thermal expansion or matching the porosities.

The segmented, ceramic layer 10, 16 has a density of from 90% to 96% of the theoretical density, in particular from 92% to 95% of the particular theoretical density, so that the density is, in particular, >5.5 g/cm³.

The vertical macrocracks 20 in the ceramic layer 10, 16 have a linear density of at least 2 macrocracks per millimeter up to a linear density of from 20 to 30 macrocracks/mm.

The ceramic powder preferably has a particle size distribution of from 10 μm to 65 μm.

The depth of the vertical macrocracks 20 in the ceramic layer 10, 16 is at least 75% of the thickness of the ceramic layer; in particular, the depth of the macrocracks 20 should be at least 90% of the layer thickness. Only these are counted when reporting the density of the macrocracks per millimeter.

1. A ceramic material
based on zirconium oxide (ZrO₂)
with ytterbium oxide (Yb₂O₃) and/or erbium oxide (Er₂O₃) as base oxide or as base oxides, and/or
with at least one further oxide, in particular with at least two further oxides,
selected from the group consisting of: yttrium oxide (Y₂O₃), cerium oxide (CeO₂), calcium oxide (CaO) and/or magnesium oxide (MgO),
in particular with the ceramic material consisting thereof.

2. The ceramic material as claimed in claim 1, comprising
only one or only two base oxide(s),
in particular only one base oxide, very particularly preferably only two base oxides.

3. The ceramic material as claimed in claim 1, comprising
only one further oxide or only a plurality of further oxides,
in particular only one further oxide, very particularly preferably only at least two further oxides.

4. The ceramic material as claimed in claim 1, comprising
at least one base oxide and at least one further oxide,
in particular only one base oxide and at least one further oxide.

5. The ceramic material as claimed in claim 1, comprising:
two base oxides and at least one further oxide,
in particular two base oxides and only one further oxide, very particularly preferably two base oxides and only two further oxides.

6. The ceramic material as claimed in claim 1,
wherein yttrium oxide (Y₂O₃) is used as further oxide,
in particular with only yttrium oxide (Y₂O₃) being used as further oxide.

7. The ceramic material as claimed in claim 1, wherein only ytterbium oxide (Yb₂O₃) is used as base oxide.

8. The ceramic material as claimed in claim 1, wherein only erbium oxide (Er₂O₃) is used as base oxide.

9. The ceramic material as claimed in claim 1, wherein only erbium oxide (Er₂O₃) and ytterbium oxide (Yb₂O₃) are used as base oxides.

10. The ceramic material as claimed in claim 1, having
calcium oxide (CaO) as further oxide, in particular only calcium oxide (CaO) as further oxide.

11. The ceramic material as claimed in claim 1,
wherein cerium oxide (CeO₂) is used as further oxide,
in particular with only cerium oxide (CeO₂) being used as further oxide.

12. The ceramic material as claimed in claim 1,
wherein magnesium oxide (MgO) is used as further oxide,
in particular with only this being used as further oxide.

13. The ceramic material as claimed in claim 1,
wherein calcium oxide (CaO) and cerium oxide (CeO₂) are used as further oxides, in particular with only these being used as further oxides.

14. The ceramic material as claimed in claim 1,
wherein calcium oxide (CaO) and magnesium oxide (MgO) are used as further oxides, in particular with only these being used as further oxides.

15. The ceramic material as claimed in claim 1,
wherein magnesium oxide (MgO) and cerium oxide (CeO₂) are used as further oxides, in particular with only these being used as further oxides.

16. The ceramic material as claimed in claim 1,
wherein magnesium oxide (MgO), calcium oxide (CaO) and cerium oxide (CeO₂) are used as further oxides,
in particular with only these being used as further oxides.

17. The ceramic material as claimed in claim 1,
wherein yttrium oxide (Y₂O₃), calcium oxide (CaO) and cerium oxide (CeO₂) are used as further oxides,
in particular with only these being used as further oxides.

18. The ceramic material as claimed in claim 1, comprising
from 2 mol % to 30 mol % of base oxides,
in particular from 4 mol % to 30 mol %,
very particularly preferably from 6 mol % to 30 mol %, of base oxides.

19. The ceramic material as claimed in claim 1, comprising
from 4 mol % to 30 mol % of further oxides,
in particular from 4 mol % to 28 mol %,
very particularly preferably from 4 mol % to 26 mol %, of further oxides.

20. The ceramic material as claimed in claim 1, comprising
from 6 mol % to 30 mol % of further oxides,
in particular from 8 mol % to 30 mol %,
very particularly preferably from 10 mol % to 30 mol %, of further oxides.

21. The ceramic material as claimed in claim 1, comprising
from 6 mol % to 28 mol % of further oxides,
in particular from 6 mol % to 26 mol %,
very particularly preferably from 10 mol % to 28 mol %, of further oxides.

22. A powder comprising a ceramic material as claimed in claim 1,
in particular consisting thereof,
which has, in particular, a particle size distribution from 10 μm to 65 μm.

23. A layer system comprising
a substrate,
in particular a metallic substrate.
based on a nickel- or cobalt-based superalloy,
a bonding layer,
in particular a bonding layer based on NiCoCrAlY,
and a ceramic layer based on a ceramic material as claimed in claim 1.

24. The layer system as claimed in claim 23 having
a layer thickness for the ceramic layer of from 20 μm to 1000 μm, in particular up to 2000 μm,
very particularly preferably produced by means of thermal spraying, in particular by means of APS or EB-PVD.

25. The layer system as claimed in claim 23, having
a density of from 90% to 96% of the theoretical density, in particular from 92% to 95% of the theoretical density, for the ceramic layer.

26. The layer system as claimed in claim 23, having
a density of at least 2 macrocracks per millimeter in the ceramic layer, where macrocracks have at least 75% of the depth of the thickness of the ceramic layer.

27. The layer system as claimed in claim 23, having
a density of from 2 to 60 macrocracks, in particular at least 40 macrocracks, very particularly preferably at least 50 macrocracks, per millimeter in the ceramic layer, where macrocracks have at least 75% of the depth of the thickness of the ceramic layer
